(19) United States
(12) Patent Application Publication
(10) Pub. No.: US 2008/0057810 A1
(43) Pub. Date: Mar. 6, 2008

(54) Production Of Absorbent Composites

(75) Inventors: Manfred Weber, Mannheim (DE); Bernhard Steinmetez, Rutschenhausen (DE); Christian Hubert Weidl, Mannheim (DE); Dennis Losch, Altrip (DE); Volker Frenz, Altleiningen (DE); Ralf Mossbach, Lindenberg (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: BASF AKTIENGESELLSCHAFT, LUDWIGSHAFEN (DE)

(21) Appl. No.: 10/587,124

(22) PCT Filed: Jan. 29, 2005
(86) PCT No.: PCT/EP05/00897

§ 371 Date: Jul. 24, 2006

(30) Foreign Application Priority Data
Feb. 3, 2004 (DE) 102004005418.5

(51) Int. Cl. B32B 5/02; B05D 3/02

(52) U.S. Cl. 442/121; 427/394

(57) ABSTRACT

A process for producing an absorbent composite by contacting a solid supporting material with an emulsion comprising at least one polymeric material and at least one crosslinker and curing the mixture on the supporting material, the absorbent composites and also their use in sealing materials for road, tunnel and water engineering and also for excavations, high water protection and roof-sealing systems.

The present invention relates to a process for producing an absorbent composite by contacting a solid supporting material with a mixture comprising at least one polymeric material and at least one crosslinker and curing the mixture on the supporting material.

There are many areas in building construction practice where built structures need to be sealed off against penetrating surface, ground, stratum or leachate water. Devices used for sealing include weldable bituminous membranes (U.S. Pat. No. 2,015,102, U.S. Pat. No. 2,160,342), plastics seals (DE-A 19930701), foam tapes (DE-A 2819604, DE-B 1223407) or clay sealing membranes.

Plastics sealing membranes and nonuniformly adhered bituminous seals have the disadvantage that water which penetrates in the event of damage can spread more or less unhindered between sealing layer and the built structure. Particularly in the case of concrete structures, water which has percolated underneath the sealing layer will then penetrate the concrete at porous places or cracks. Rust is formed on the reinforcing steel. Damp places form on the inner surface of walls and ceilings. Furthermore, water can percolate through to the joints and emerge there. Clay sealing membranes usually utilize bentonite sealing material, which, unlike the geotextiles frequently used as a supporting material, is not filter stable. Bentonite can be washed off by percolating water, as a result of which the sealing effect is lost. In contrast, clay sealing membranes prevent the longitudinal percolation of penetrated water by virtue of the bentonite which exits from the surface on swelling.

There are two recognized ways to seal off cellars, underground carparks, groundwater tanking systems or similar built structures against the external pressure of water from soil layers, for example hillside water or groundwater in building and civil engineering.

The usual choice is the white tanking system, which utilizes waterproof concrete, costly additional reinforcement to avoid cracks and tape to seal the joints between the individual components or construction joints. Any cracks which appear nonetheless are injected with resin.

The black tanking system is so called because of the bituminous sealing membranes typically used. But lately plastics seals have come to be used as well (DE-A 19930701).

Underground and underwater cables are sealed by wrapping the respective wires and wire junctions with nonwovens or tapes, which nonwovens or tapes constitute supporting materials for hydrogels or superabsorbents. The EP-A-0 269 778 patent application teaches the production of such swellable nonwovens by incorporating superabsorbents in a balt formed from two superimposed webs. An alternative method for obtaining water-absorbing and swellable materials is described in the DE-A-42 43 254 patent application wherein, however, water-absorbing clay materials are introduced between two webs and fixed by subsequent needling.

The use of such nonwovens and/or yarns to reduce the longitudinal propagation of water in cable structures is described in the DE-A-43 06 835 and DE-A-43 16 574 patent applications.

The absorbent composites of the present invention can further be used for agri- or horticultural applications, for example to enhance water retention, for climate control, for example to regulate the humidity in rooms and containers, and for sheeted absorption of water or aqueous fluids, for example for moisture regulation in sitting or lying furniture.

The DE-A-1 95 21 431 patent application describes swelling pastes for cable insulation. Swelling pastes are highly viscous hydrogels consisting of a precrosslinked polyacrylic acid and ethylene glycol diglycidyl ether. The reference teaches that polyacrylic acid which is not precrosslinked provides only very hard and inflexible swellable nonwovens. The swelling pastes are highly viscous because of the necessary precrosslinking, and this hinders their processing.

The U.S. Pat. No. 5,278,217 patent describes cable-insulating systems comprising mixtures of thermoplastic elastomers and water-absorptive resins. The water-absorptive resins are granular superabsorbent polymers which may have been surface postcrosslinked.

The EP-A-0 188 091, EP-A-0 357 474 and EP-A-0 930 078 patent applications describe absorbent composites for use in hygiene articles. The absorbent composites are produced by drenching polymeric fibers with a solution or dispersion comprising crosslinkable superabsorbent polymers. The superabsorbent polymers are crosslinked in the presence of the polymeric fibers.

EP-A-0 188 091 utilizes a polyacrylic acid dispersion. The level of uncrosslinked prepolymer is about 12% by weight.

EP-A-0 357 474 utilizes a polyacrylic acid solution comprising zirconium ions as a crosslinker. The polymer content of the solution is 12.5% by weight.

The solutions/dispersions used in the abovementioned processes are very dilute, so that large amounts of solvent are needed.

Prior German patent application 10241530.7 describes absorbent composites which by contacting a polypropylene-based nonwoven with an emulsion comprising a swellable polymer based on acrylic acid.

The present invention has for its object to remedy the disadvantages described and to provide novel absorbent composites for use in sealing materials for road, tunnel and water engineering and also for excavations, high water protection and roof-sealing systems, for agri- or horticultural applications, for climate control, and also for sheeted absorption of water or aqueous fluids, which novel absorbent composites shall in particular provide improved adhesion of absorbent material to supporting material.

A further object of the present invention is an improved process for producing the abovementioned absorbent composites in that neither highly viscous hydrogels nor very dilute solutions or dispersions shall be utilized.

The present invention accordingly provides a process for producing an absorbent composite by contacting a solid supporting material with an emulsion comprising at least one polymeric material and at least one crosslinker and curing the mixture on the supporting material.

The present invention further provides for the use of polymeric emulsions for producing absorbent composites.

The present invention further provides absorbent composites having improved fiber bonding which are obtainable by the abovementioned process.

The present invention further provides for the use of the absorbent composites of the present invention in sealing materials for road, tunnel and water engineering and also for excavations, high water protection and roof-sealing systems.

The present invention further provides improved sealing materials comprising the absorbent composites of the present invention for road, tunnel and water engineering and also for excavations, high water protection and roof-sealing systems.

Useful supporting materials for producing the composites of the present invention include for example appropriate nonwovens, formed-loop knits, wovens or drawn-loop knits or combinations thereof. Nonwoven customarily refers to a structure which has not been woven nor loop-formingly knitted and which may comprise fibers or tapes. Formed-loop knits are textile structures formed by forming mutually supporting loops. Wovens are textile structures formed of yarns or tapes which cross at right angles on weaving machines for example. Useful supporting materials for the present invention are preferably in the form of wovens or nonwovens. Useful nonwovens include for example spunbonded nonwovens, needled nonwovens or else hydroentangled nonwovens. The nonwovens may be consolidated mechanically, thermally or chemically. Useful supporting materials for the present invention are preferably sheetlike structures having any desired thickness, more preferably the thickness of the sheetlike structures is in the range from 1 to 200 mm and especially in the range from 5 to 50 mm.

The textile supporting materials which are useful according to the present invention can consist of tapes or of fibers, in which case the latter are preferred. Useful tapes include for example fibrilated tapes, especially those composed of textile materials or fibrilated film tapes composed of customary film materials, such as for example plastics, such as polyethylene and/or polypropylene. The fibers used can be staple fibers or continuous filament fibers (filaments). The fibers can be for example synthetic, mineral or natural in kind, in which case especially synthetic and/or mineral fibers are used. Examples of synthetic fibers are fibers composed of polyethylene, polypropylene, polybutylene terephthalate, polyamide, polyethylene terephthalate, polyester, polysulfone and/or polyether ketone. Mineral fibers can consist for example of ceramic materials, silicon carbide and/or boron nitride. It is also possible to use fibers composed of carbon or glass fibers.

Preferred supporting materials are polyethylene, polypropylene, polybutylene terephthalate, polyamide, polyethylene terephthalate, polyester, polysulfone and/or polyether ketone, especially polypropylene.

Useful polymeric materials include for example carboxyl-rich polymers, preferably based on homo- or copolymers of unsaturated carboxylic acids or their derivatives. Carboxyl-rich polymer is to be understood as meaning that not less than 50 mol %, preferably not less than 75 mol % and more preferably not less than 95 mol % of the polymer is polymerized from unsaturated carboxylic acid monomer.

The carboxyl-rich polymers used as polymeric materials are applied to the supporting material in the form of an emulsion of organic solvents and water as well as the carboxyl-rich polymers.

Useful organic solvents are the solvents customarily used in chemical technology, including aliphatic, cycloaliphatic or aromatic hydrocarbons, for example hexane or heptane, cyclohexane, toluene or xylenes. In addition it is conceivable to use organic ether compounds such as for example petroleum ethers or tetrahydrofuran and also halogenated hydrocarbons. Very useful organic solvents further include mineral oils, but also natural oils such as for example rape seed oil.

Useful mineral oils for this purpose are the liquid distillation products which are essentially recovered from mineral raw materials, such as petroleum, coal, wood or peat, and which consist predominantly of mixtures of saturated hydrocarbons. Examples of such mineral oils include gasoline, diesel oils, heating oils, lubricating oils, lamp oil or insulating oils.

As well as organic solvents and water, the emulsion used according to the present invention contains carboxyl-rich polymers, preferably based on copolymers of allylically or vinylically unsaturated carboxylic acids or their derivatives, for example their esters, amides or nitriles and also anhydrides.

The carboxyl-rich polymers may include allylically or vinylically unsaturated mono- or dicarboxylic acids as principal monomers. Vinylically unsaturated mono- or dicarboxylic acids are preferred including acrylic acid and/or methacrylic acid and also maleic acid, fumaric acid or itaconic acid or their esters, amides, nitriles or anhydrides. Preferred principal monomers are acrylic acid and also methacrylic acid, of which acrylic acid is particularly preferred.

The fraction which these principal monomers contribute to the overall carboxyl-rich polymer is preferably not less than 60% by weight, especially not less than 70% by weight and more preferably not less than 80% by weight. Accordingly, the fraction attributable to the comonomer or comonomers not more than 40% by weight, especially not more than 30% by weight and more preferably not more than 20% by weight.

The carboxyl-rich polymers may contain one or more of the following comonomers:
esters of preferably C3-C6 α,β-monoethylenically unsaturated mono- or dicarboxylic acids, such as acrylic acid, methacrylic acid, maleic acid, fumaric acid and itaconic acid with C₁-C₁₂ alkanols and preferably C₁-C₈ alkanols. Such esters are in particular methyl, ethyl, n-butyl, isobutyl, tert-butyl, n-pentyl, isopentyl and 2-ethylhexyl acrylate and/or methacrylate;
acrylonitrile, methacrylonitrile;
acrylamides and alkyl-substituted acrylamides, for example acrylamide, methacrylamide, N,N-dimethylacrylamide, N-methylolmethacrylamide, N-tert-butylacrylamide, N-methylmethacrylamide, methylenebisacrylamide and mixtures thereof;
sulfo-containing monomers, for example allylsulfonic acid, methallylsulfonic acid, styrenesulfonic acid, vinylsulfonic acid, 2-acrylamido-2-methylpropanesulfonic acid, allyloxybenzenesulfonic acid, their corresponding alkali metal or ammonium salts or mixtures thereof and also sulfopropyl acrylate and/or sulfopropyl methacrylate;

C₁-C₄ hydroxyalkyl esters of C₃-C₆ mono- or dicarboxylic acids, especially of acrylic acid or methacrylic acid or maleic acid, or their derivatives alkoxylated with from 2 to 50 mol of ethylene oxide, propylene oxide, butylene oxide or mixtures thereof or esters with the aforementioned acids of C₁-C₁₈ alcohols alkoxylated with from 2 to 50 mol of ethylene oxide, propylene oxide, butylene oxide or mixtures thereof, for example hydroxyethyl acrylate, hydroxyethyl methacrylate, hydroxypropyl acrylate, hydroxypropyl methacrylate, 1,4-butanediol monoacrylate, ethyldiglycol acrylate, methylpolyglycol acrylate, (meth)acrylic acid esters of C₁₃/C₁₅ oxo alcohol reacted with 3, 5, 7, 10 or 30 mol of ethylene oxide, or mixtures thereof;
alkylaminoalkyl (meth)acrylates, such as 2-(N,N-dimethylamino)ethyl or 3-(N,N-dimethylamino)propyl (meth)acrylate, alkylaminoalkyl(meth)acrylamide, such as 2-(N,N-dimethylamino)ethyl(meth)acrylamide or 3-(N,N-dimethylamino)propyl(meth)acrylamide, their quaternization products, such as 2-(N,N,N-trimethylammonio)ethyl methacrylate chloride or 3-(N,N,N-trimethylammonio) propyl(meth)acrylamide chloride, and also mixtures thereof;
monomers containing 1,3-diketo groups, for example acetoacetoxyethyl (meth)acrylate or diacetoneacrylamide, monomers containing urea groups, such as ureidoethyl (meth)acrylate, acrylamidoglycolic acid, methacrylamidoglycolate methyl ether;
silyl-containing monomers, for example trimethoxysilylpropyl methacrylate.

Particularly preferred comonomers include esters or amides of acrylic acid or methacrylic acid for example n-butyl acrylate, butyl methacrylate 2-ethylhexyl acrylate and/or methacrylate, acrylamide or methacrylamide.

The carboxyl-rich polymers to be used according to the present invention may also comprise up to 2% by weight, especially up to 1% by weight and preferably up to 0.5% by weight of bi- or multifunctional comonomers which ensure easy crosslinking of the resultant carboxyl-rich polymers. Useful comonomers for this purpose include methylenebisacrylamide, for example. Further useful bi- or multifunctional monomers are described for example in WO-A 93/21237. The incorporation of bi- or multifunctional monomers produces polymers which are substantially water insoluble yet still swellable. Preferably, however, no bi- or multifunctional monomers are used in the emulsion polymerization.

Such carboxyl-rich polymers are preferably prepared by free-radical polymerization in the emulsion of organic solvents and water.

The polymerization is preferably carried out in the presence of compounds (initiators) which form free radicals. These compounds are preferably needed in an amount from 0.05 to 10% by weight and more preferably from 0.2 to 5% by weight, based on the monomers used in the polymerization.

Useful polymerization initiators include for example peroxides, hydroperoxides, peroxodisulfates, percarbonates, peroxoesters, hydrogen peroxide and azo compounds. Examples of initiators, which may be soluble or else insoluble in water, are hydrogen peroxide, dibenzoyl peroxide, dicyclohexyl peroxydicarbonate, dilauroyl peroxide, methyl ethyl ketone peroxide, di-tert-butyl peroxide, acetylacetone peroxide, tert-butyl hydroperoxide, cumene hydroperoxide, tert-butyl perneodecanoate, tert-amyl perpivalate, tert-butyl perpivalate, tert-butyl perneohexanoate, tert-butyl per-2-ethylhexanoate, tert-butyl perbenzoate, lithium, sodium, potassium and ammonium peroxodisulfate, azodiisobutyronitrile, 2,2′-azobis(2-amidinopropane) dihydrochloride, 2-(carbamoylazo)isobutyronitrile and 4,4-azobis(4-cyanovaleric acid). It is similarly possible to use the familiar redox initiator systems such as, for example, H₂0₂/ascorbic acid or t-butyl hydroperoxide/sodium hydroxymethanesulfinate as polymerization initiators.

The initiators may be used alone or mixed with each other, for example mixtures of hydrogen peroxide and sodium peroxodisulfate. The polymerization in an aqueous medium is preferably carried out using water-soluble initiators.

The emulsions to be used according to the present invention may further contain customary additives, depending on the intended application. They may contain bactericides or fungicides for example. They may further contain hydrophobicizing agents to enhance the water resistance of the treated substrates. Useful hydrophobicizing agents include customary aqueous paraffin dispersions or silicones. The compositions may further contain wetting agents, thickeners, dispersants, plasticizers, retention aids, pigments and fillers. These fillers may also be mixed in using inductive heating to facilitate curing.

The emulsions of organic solvent, water and carboxyl-rich polymer which are used to introduce the polymeric materials may be stabilized by means of surface-active assistants. Typically, emulsifiers or protective colloids are used. Anionic, nonionic, cationic and amphoteric emulsifiers may be used. Examples of anionic emulsifiers are alkylbenzenesulfonic acids, sulfonated fatty acids, sulfosuccinates, fatty alcohol sulfates, alkylphenol sulfates and fatty alcohol ether sulfates. Examples of nonionic emulsifiers are alkylphenol ethoxylates, primary alcohol ethoxylates, fatty acid ethoxylates, alkanolamide ethoxylates, fatty amine ethoxylates, EO/PO block copolymers and alkylpolyglucosides. Examples of cationic and amphoteric emulsifiers used are quaternized amine alkoxylates, alkylbetaines, alkylamidobetaines and sulfobetaines.

Examples of typical protective colloids are cellulose derivatives, polyethylene glycol, polypropylene glycol, copolymers of ethylene glycol and propylene glycol, polyvinyl acetate, polyvinyl alcohol, polyvinyl ether, starch and starch derivatives, dextran, polyvinylpyrrolidone, polyvinylpyridine, polyethyleneimine, polyvinylimidazole, polyvinylsuccinimide, polyvinyl-2-methylsuccinimide, polyvinyl-1,3-oxazolid-2-one, polyvinyl-2-methylimidazoline and maleic acid or maleic anhydride copolymers as described for example in DE-A 2 501 123.

The emulsifiers or protective colloids are customarily used in concentrations of from 0.05 to 20% by weight, based on the monomers.

The monomers of the carboxyl-rich polymers may be wholly or partly neutralized with bases before or during the polymerization. Useful bases include for example alkali metal or alkaline earth metal compounds such as sodium hydroxide, potassium hydroxide, calcium hydroxide, magnesium oxide and/or sodium carbonate, ammonia, primary, secondary and/or tertiary amines, such as ethylamine, propylamine, isopropylamine, butylamine, hexylamine, ethanolamine, dimethylamine, diethylamine, di-n-propylamine, tributylamine, triethanolamine, dimethoxyethylamine, 2-ethoxyethylamine, 3-ethoxypropylamine, dimethylethanolamine, diisopropanolamine or morpholine. Preference is given to using sodium hydroxide.

The ratio of aqueous to organic phase in the emulsion polymerization is typically in the range from 0.5 to 10, preferably in the range from 1 to 5 and more preferably in the range from 2 to 4. It is preferable to use mineral oils as organic phase.

The reaction temperature for the emulsion polymerization is typically below 100° C., preferably below 90° C. and more preferably below 80° C.

After the polymerization has ended, the emulsion comprising the polymeric material is admixed with a crosslinker. Crosslinkers useful for the purposes of the present invention are preferably covalent crosslinkers, i.e., crosslinking is effected through the formation of covalent bonds, for example ethylene glycol diglycidyl ether, diethylene glycol diglycidyl ether, polyethylene glycol diglycidyl ether, propylene glycol diglycidyl ether, dipropylene glycol diglycidyl ether, polypropylene glycol diglycidyl ether, glycerol diglycidyl ether, polyglycerol diglycidyl ether, epichlorohydrin, ethylenediamine, ethylene glycol, diethylene glycol, triethylene glycol, polyethylene glycol, propylene glycol, dipropylene glycol, tripropylene glycol, polypropylene glycol, butylene glycol, 1,3-propanediol, 1,4-butanediol, bisphenol A, glycerol, trimethylolpropane, pentaerythritol, sorbitol, diethanolamine, triethanolamine, ethylenediamine, ethylene carbonate, propylene carbonate, 2-oxazolidones, such as 2-oxazolidinone or N-hydroxyethyl-2-oxazolidinone, 2,3-morpholinediones, such as N-2-hydroxyethyl-2,3-morpholinedione, N-methyl-2,3-morpholinedione, N-ethyl-2,3-morpholinedione and/or N-tert-butyl-2,3-morpholinedione, 2-oxotetrahydro-1,3-oxazine, N-acyl-2-oxazolidones, such as N-acetyl-2-oxazolidone, bicyclic amide acetals, such as 5-methyl-1-aza-4,6-dioxabicyclo[3.3.0]octane, 1-aza-4,6-dioxabicyclo[3.3.0]octane and/or 5-isopropyl-1-aza-4,6-dioxabicyclo[3.3.0]octane, and/or bis- and poly-2-oxazolidinones. Preference is given to diepoxides, such as ethylene glycol diglycidyl ether, diethylene glycol diglycidyl ether, polyethylene glycol diglycidyl ether, propylene glycol diglycidyl ether, dipropylene glycol diglycidyl ether, polypropylene glycol diglycidyl ether, glycerol diglycidyl ether and also polyglycerol diglycidyl ether, and very particular preference is given to ethylene glycol diglycidyl ether and diethylene glycol diglycidyl ether.

The crosslinker can be used in an amount of from 0.01% to 10% by weight and preferably from 0.5% to 2% by weight, based on the polymeric material. The absorbent composites of the present invention may be produced for example by coating, impregnating, padding, foaming or spraying the supporting material with the emulsion comprising the at least one polymeric material and the at least one crosslinker. Preferably, the supporting materials are saturated with the emulsion, more preferably by dipping into an impregnating trough filled with the emulsion. The supporting material loaded with emulsion is subsequently led through two rolls above the impregnating cloth. This serves to squeeze off excess emulsion, which drains back into the trough.

The emulsion-loaded supporting material can be dried at temperatures of up to 200° C., preferably in the range from 80 to 180° C. and more preferably in the range from 100 to 140° C. Preferably in an air stream. Useful dryers include for example cylinder dryers, drum dryers and roll dryers.

During drying, the supporting material and the polymeric material become crosslinked within and between each other.

When the supporting material is a fiber web, it is also possible to employ a Maliwatt process. In this process, a web consisting of fibers laid down at right angles to the machine direction is consolidated by stitch bonding the fibrous plies together with external yarn in the longitudinal direction at a spacing of about 1 mm. The emulsion comprising at least one polymeric material and the at least one crosslinker is then incorporated in this fibrous layer.

Instead of a fiber web, it is also possible to use textile wovens.

The fibers and/or tapes on the one hand and also the swellable materials present in the absorbent composites are each present in such an amount that the fibers and/or tapes are encased by the swellable materials and the voids in the absorbent composite are in the swollen state completely filled by materially bound water. The optimum amount of swellable material can be determined for example by preliminary experimentation. To this end, the amount M [g] of emulsion comprising at least one polymeric material and the at least one crosslinker is weighed out, dried in the absence of the supporting material and the volume Q [ml] determined after swelling in water. The optimum loading B [g] of the supporting material with the emulsion is then given by

$$B = V \times \frac{M}{Q} ,$$

where V [ml] is the maximum volume to which the supporting material can be expanded. By way of approximation, the weight G [g] after swelling can also be used in the calculation instead of the volume Q. In this case, the optimum loading B of the supporting material with the emulsion is given by

$$B = V \times \frac{M}{G} \times 1 \frac{g}{m 1} .$$

The values thus determined should usually not be under- or overattained by more than 50%, preferably 30% and more preferably 10%. Excessively low loadings lead to reduced absorption capacity. Excessively high loadings lead to tearing of the absorbent composite or to hydrogel oozing out of the absorbent composite.

With regard to the amount of swellable materials, it is customary to use from 0.05 to 20 kg and especially from 0.1 to 10 kg of these swellable materials per m² of ready-produced swellable nonwoven. As regards the amount of fibers and/or tapes per m² of ready-produced swellable nonwoven, it is customarily in the range from 0.1 to 2 kg and especially in the range from 0.15 to 1 kg.

To achieve water imperviousness in the horizontal plane, the supporting material has to be drenched with the polymeric materials such that complete encasement of the fibers is achieved.

The absorbent composites of the present invention may also comprise combinations of carboxyl-rich polymers on the one hand and granular superabsorbent polymers based on partially neutralized crosslinked polyacrylic acids on the other. The partially neutralized polyacrylic acid superabsorbents can be crosslinked with customary crosslinkers, which preferably comprise at least two ethylenically unsaturated double bonds, one ethylenically unsaturated double bond and one further functional group or else two functional groups. The functional groups of these crosslinkers should be capable of reacting with the acid groups of acrylic acid. Useful functional groups include for example hydroxyl, amino, epoxy and aziridino groups. The granular superabsorbent polymers based on partially neutralized crosslinked polyacrylic acids typically have particle sizes in the range from 200 to 800 pm.

It may also be advisable for the water-remote side of the present invention's absorbent composites formed from fibers and/or tapes and also swellable materials to have a mixture of granular superabsorbent polymers based on partially neutralized crosslinked polyacrylic acids on the one hand and a powder of polymers on the other applied to it. Suitable for this purpose are in particular thermoplastic powders of polyolefins such as polyethylene or polypropylene. A blend ratio between the granular superabsorbent polymer and the polymer powder should be maintained in the range from about 0.5:1 to 5:1 and especially in the range from 1:1 to 3:1. The resulting mixture of granular superabsorbent polymer and the polymer powder may then be covered with an absorbent composite which has a basis weight of about 50-80 g/m² and an effective aperture size of less than 0.12 mm and subsequently be bonded by heat and pressure to the absorbent composite of the present invention. This ensures that, in the installed state, the swollen swellable material of the absorbent composite of the present invention can prop itself up against the likewise swollen granular superabsorbent polymer. This prevents the swellable material being flushed out of the absorbent composite.

The absorbent composites of the present invention may form part of seals which, as well as the absorbent composite, preferably further comprise at least one sealing membrane composed of plastics. Preference here is given to an arrangement in which the seal comprises an absorbent composite which is disposed between two sealing membranes composed of plastics. The absorbent composite may in this arrangement be secured to the sealing membranes in a conventional manner, for example by hook engagement, adhering, tying or by calendering under pressure and heat.

The absorbent composite of the present invention may be used inter alia as a sealing material for road, tunnel and water engineering and also for excavations, highwater protection and roof sealing systems. Specifically in the case of excavations, in road engineering and highwater protection, the absorbent composite of the present invention may also be used either alone or else combined with mixtures of granular superabsorbent polymers and powders of other polymers. Conceivable arrangements include in particular the installation of the absorbent composite underneath a sealing membrane of plastic, against the built structure to be protected, to prevent underseepage in the event of damage to the sealing membrane, for example for flat roofs in building construction, in the case of tunnels in open construction and also in the case of seals for subbasements or underground carparks.

Other possible applications for the absorbent composite relate to its use between two sealing membranes as self-healing seals in tunnel engineering (as per DE-A 19625245) and also as part of a membrane tanking system in traffic route engineering (as per DE-A 19930701) or in building and civil engineering.

Further possible applications for the absorbent composite according to the present invention relate to its installation underneath the concrete protective layer for a plastics sealing membrane in basins and channels to prevent percolate flow underneath the concrete slabs to damaged sites in the plastics seal and to reduce the stress in the concrete slabs through reduced friction. Examples thereof will include the installation of the absorbent composites in rainwater retention basins, agricultural ponds, sludge basins and also in irrigation and power plant channels in the case of coarsely granular soils.

It is further conceivable to install the absorbent composite either alone or else in conjunction with other sealing membranes in soil instead of clay sealing membranes, especially in irrigation and discharge channels, for sealing agricultural ponds, storage ponds or pollution control areas, for creating artificial groundwater carriers and for the first sealing of membrane tanking systems and excavations.

The absorbent composites of the present invention may also be used in combination with protective nonwovens which are used to protect seals. Such protective nonwovens do not hinder the flow of water to the damaged site in the case of damage in the seal in granular soils (vertical perviousness). In the case of firmer soils, they promote the collection and distribution of the water flowing through the site of damage (horizontal perviousness). The absorbent composite of the present invention when used in this function enhances safety by virtue of its sealing performance.

A further way of using the absorbent composite of the present invention is to use it as a lining and seal in wire baskets which can be rapidly set up as a temporary highwater barrier or in water engineering and then filled mechanically with spall, gravel or recyclate.

The absorbent composites of the present invention are simple to produce. Solvent requirements are down compared with the prior art without there being any need to process highly viscous mixtures. It is a particular advantage here that emulsions of uncrosslinked polymers can be used. These solutions are notable for a particularly low viscosity and are particularly easy to process. The adhesion of the swellable material to the supporting material is improved. The solubles fraction, i.e., the fraction of polymers which can be leached out of the absorbent composite, and hydrogel ooze in use are distinctly reduced compared with the prior art.

The absorbent composites of the present invention are superior to prior art textile wovens or nonwovens, inter alia because of superior processibility (machine laying is a possibility) and swellability and also higher water imperviousness, including especially in the horizontal direction. When the absorbent composite is installed as a protective ply, it prevents the spreading of water and by virtue of its buffering action provides greater safety against customary damage. This is the result of the fibers or tapes which are present being completely encased by materially bound water, so that no water- ducting layers are formed. Furthermore, they are very readily laminable with sealing membranes.

### EXAMPLES

### Example 1

104.5 g of demineralized water were mixed with 562.5 g of acrylic acid (99.8%) pure and also 1246.0 g of 25% aqueous sodium hydroxide solution, 5.63 g of 1% aqueous methylene bisacrylamide, 1.25 g of 40% aqueous Trilon® C and 3.38 g of 1% aqueous Rongalit® C in a stirred vessel to form an aqueous phase. A second sealed stirred vessel (2 liter HWS equipped with anchor stirrer) was charged with 500 g of Shellsol® D 70 (100%) and 70 g of Emulan® GOE (100%) to form an organic phase, into which the aqueous phase was metered.

The combined aqueous and organic phases were then pre-emulsified in the second stirred vessel at 400 revolutions per minute for 60 minutes at 31° C. in a (15 liters/hour) stream of nitrogen and with bath immersion for temperature control. Thereafter, the speed of the stirrer was reduced to 200 revolutions per minute and 3.94 g of 10% aqueous sodium persulfate solution were added.

The polymerization kicked off immediately. When the internal temperature reached 35° C., the temperature-controlling bath was removed. The internal temperature reached a maximum of 66.2° C. After the temperature had decreased by 1° C., 28.13 g of 10% aqueous sodium persulfate solution was added followed 10 minutes later by 19.69 g of 1% aqueous Rongalit solution.

After the emulsion had cooled down, 12.5 g of Denacol EX 810 were added to it and the emulsion was mixed through at 200 revolutions per minute for a further 5 minutes. This gave an emulsion of mineral oil, water, carboxyl-rich acrylic acid copolymer and crosslinker.

| | |
|---|---|
| Shellsol ® D 70 | Mineral oil from Shell AG |
| Emulan ® GOE | Emulsifier from BASF Aktiengesellschaft, based on |
| | oleyl glycerol ether ethoxylate |
| Trilon ® C | Complexing agent from BASF Aktiengesellschaft, |
| | based on the trisodium salt of |
| | hydroxyethylethylenediaminetriacetic acid in water |
| Rongalit ® C | Reducing agent from BASF Aktiengesellschaft, |
| | based on the sodium salt of hydroxymethanesulfinic |
| | acid |
| Denacol ® EX 810 | Postcrosslinker from Nagase, based on |
| | ethylene glycol diglycidyl ether |

### Example 2

A polyester needlefelt nonwoven fabric having a basis weight of 280 g/m² was saturated with the emulsion prepared in Example 1. A pad-mangle was used. The pad-mangle consisted of a trough filled with the emulsion and two stripping rolls having confining walls on the side. The fabric was led through the pad-mangle at a speed of 1 meter per minute. The emulsion-loaded fabric was dried at 170° C. for 5 minutes. The absorbent composite had a basis weight of 410 g/m², the weight increase (solids add-on) was 46%.

The absorbent composite was placed in water and an hour later the water uptake was determined by weighing back. The fabrics were further tested manually for hydrogel ooze and hence for leaching losses from the fabrics after particular times. A wetting test was carried out in addition. To this end, a droplet of water was applied to the surface of the absorbent composite and the time taken for the drop to disappear from the surface was measured. The results are summarized in Table 1.

### Example 3

Example 2 was repeated using nonwoven polyester quilting having a basis weight of 80 g/m².

TABLE 1

| | Example 2 | Example 3 |
|---|---|---|
| Solids add-on | 46% | 98% |
| Wetting | 10 seconds | about 1 second |
| Hydrogel ooze | none | none |
| Water uptake | 1000 g/m² | 600 g/m² |

1. A process for producing an absorbent composite comprising contacting a solid supporting material with a mixture comprising at least one polymeric material and at least one crosslinker and curing the mixture on the supporting material, wherein the polymeric material comprises a carboxyl-rich polymer, not less than 50 mol % of the polymer being polymerized from unsaturated carboxylic acid monomers, the monomers of the carboxyl-rich polymer being wholly or partly neutralized with a base before or during the polymerization, and the mixture is an emulsion.

2. The process of claim 1 wherein the supporting material comprises fibers, tapes, or a mixture thereof.

3. The process of claim 1 wherein the supporting material comprises wovens, nonwovens, or a mixture thereof.

4. The process of claim 2 wherein the fibers are filaments, staple fibers, or a mixture thereof.

5. The process of claim 2 wherein the fibers are synthetic fibers.

6. The process of claim 1 wherein the emulsion comprises an organic solvent.

7. The process of claim 1 wherein the polymeric material comprises a carboxylic-rich polymer based on a copolymer of vinylically or allylically unsaturated carboxylic acids, or both, or their derivatives, or mixtures thereof.

8. The process of claim 1 wherein the polymeric material comprises a polymer based on a copolymer of acrylic acid, an ester or an amide of acrylic acid, methacrylic acid, and mixtures thereof.

9. The process of claim 8 wherein the polymeric material further comprises a granular superabsorbent polymer based on partially neutralized crosslinked polyacrylic acid.

10. The process of claim 1 utilizing a covalent crosslinking agent.

11. The process of claim 10 wherein the covalent crosslinking agent comprises a diepoxide.

12. The process of claim 1 wherein the curing is effected in a range from 100 to 200° C.

13. The process of claim 1 wherein the supporting material is coated, impregnated, padded, foamed, or sprayed with at least one polymeric material and subsequently cured.

14. An absorbent composite prepared by the process of claim 1 wherein the polymeric material is prepared by an emulsion polymerization.

15. A close-out comprising at least one absorbent composite of claim 1 and at least one sealing membrane comprising a plastic.

16. The close-out of claim 15 wherein the absorbent composite is disposed between two sealing membranes comprising a plastic.

17. (canceled)

18. (canceled)

19. A sealing material for a cable sheath comprising an absorbent composite of claim 14.

20. The sealing material of claim 19 to enhance water retention in agriculture and horticulture, to regulate humidity in rooms and containers, and for moisture regulation in sitting or lying furniture.

21. The process of claim 6 wherein the organic solvent comprises a mineral oil.
